(19) United States
(12) Patent Application Publication
(10) Pub. No.: US 2010/0122176 A1
(43) Pub. Date: May 13, 2010

(54) Collection, analysis and feedback system for consumption information

(76) Inventor: Zhou Ye, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,186

(22) Filed: Nov. 13, 2008

(51) Int. Cl. G06F 3/048

(52) U.S. Cl. 715/738

(57) ABSTRACT

A collection, analysis and feedback system for consumption information includes a remote computer that is connected with a network and displays a graphical user interface so that the user can input or set an option, a user database that stores a plurality of user data and is connected with the remote computer via the network, a commodity database that stores a plurality of commodity icons, and a network activity database that makes the remote computer to load in the user data via the network. The network activity database transmits a variety of operation requests to the remote computer and displays the operation request on the graphical user interface. The remote computer sends the selection requests to the commodity database and the operation requests to the network activity database so that the commodity database outputs and transmits the statistical data to the user database to update the loaded user data.

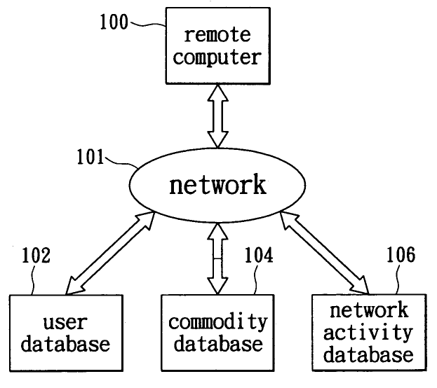

### BACKGROUND OF THE INVENTION

1. Field of the Invention

The present invention relates to a collection, analysis and feedback system for consumption information. In particular, the present invention relates to a collection, analysis and feedback system for consumption information in which the consumer, the designer, the manufacturer, the agent and the seller of commodities can exchange consumption information of a variety of commodity icons and the network activity database, such as network chat rooms or online game platforms.

2. Description of Related Art

As electronic technology and network technology are rapidly developing, commodities are promoted by network, such as network poll, electronic paper, network auction, network market, BLOG marketing, etc. In addition to follow the trend of network application, this way also can improve the flexibility and efficiency of the commodity promotion.

As network technology is improving, network chat and online games are also rapidly developing. Among network users, the ratio of users who participate in network chat and online games is high. Using software programs and friendly user interfaces, users can easily engage in network chat or online games.

Therefore, if designers, manufacturers, agents and sellers of commodities still merely use the traditional commodity promotion and do not adopt crossover cooperation by applying network technology, flexibility and efficiency of the commodity promotion will suffer, and advantageous market positions cannot be achieved.

### SUMMARY OF THE INVENTION

One particular aspect of the present invention is to provide a collection, analysis and feedback system for consumption information so that consumers, designers, manufacturers, agents, and sellers of commodities can exchange consumption information.

The collection, analysis and feedback system for consumption information includes a remote computer. The remote computer is connected with a network and displays a graphical user interface so that the user can input an option or set an option. The collection, analysis and feedback system for consumption information includes a user database that stores a plurality of user data and is connected with the remote computer via the network, a commodity database that stores a plurality of commodity icons, and a network activity database that makes the remote computer load the user data via the network. The plurality of user data respectively correspond to a user code. After the user database receives a user code from the remote computer, user data that corresponds to the user code is loaded and displayed on the graphical user interface of the remote computer. The commodity database utilizes the network to receive the loaded user data from the remote computer or the user database, and selects a set of commodity icons according to the loaded user data. Each commodity icon that meets a selection request is transmitted and displayed on the graphical user interface of the remote computer. The network activity database transmits a variety of operation requests to the remote computer and displays the operation request on the graphical user interface. By utilizing the remote computer to send the selection requests to the commodity database and send the operation requests to the network activity database, the commodity database accumulates the number the selected commodity icon was sent and outputs statistical data and transmits the statistical data to the user database to update the loaded user data. The network activity database generates an evaluation result according to the sent operation request, and transmits the evaluation result to the user database to update the loaded user data.

The present invention has the following characteristics. The designer, the manufacturer, the agent and the seller can provide commodity icons to obtain consumption information, such as the user's likes and popular trends, and applies consumption information to their business activity, such as changing the design or the promotion strategy. Moreover, the user (the consumer) can obtain the reference evaluation represented by the evaluation result by selecting the commodity icon to know the popular consumption trend. Therefore, the trader and the consumer can interact with each other in the collection, analysis and feedback system for consumption information to obtain the required consumption information.

For further understanding of the present invention, reference is made to the following detailed description illustrating the embodiments and examples of the present invention. The description is for illustrative purpose only and is not intended to limit the scope of the claims.

### BRIEF DESCRIPTION OF THE DRAWINGS

The drawings included herein provide a further understanding of the present invention. A brief introduction of the drawings is as follows:

The FIGURE is a block diagram of the operation device of the graphical user interface of the present invention.

### DETAILED DESCRIPTION OF PREFERRED EMBODIMENTS

Reference is made to the FIGURE, which shows a block diagram of the collection, analysis and feedback system for consumption information of the present invention. The collection, analysis and feedback system for consumption information includes a remote computer 100, a network 101, a user database 102, a commodity database 104, and a network activity database 106. The remote computer 100 includes a display device, a storage device, an output/input device and a wired or wireless communication device. The network 101 is an Internet, local area network, a proprietary network, or a wireless communication network. The remote computer 100 is connected with the network via the wired or wireless communication device. For example, the remote computer can be linked to the network 101 via a modem, or a cell phone can make the remote computer 100 be linked with the network 101 via a wireless communication network. The remote computer 100 uses the display device to display a graphical user interface. The user can utilize the input device to input a selection or setting option, and interact with the graphical user interface.

The user database 102 stores a plurality of user data, and is connected with the remote computer 100 via the network 101. Each of the user data corresponds to a user code, including a user name and password. In this embodiment, after the user database 102 receives a user code from the remote computer 100, the user data corresponding to the user code is loaded and displayed on the graphical user interface of the remote computer 100. The user data includes the sex distinction, birthday, height, weight, hobby, resident area, education of the user, or the outline of the user body, such as the ratio of the height, physique, or the three measurements of the user body. In this embodiment, the outline of the user body can be loaded and displayed on the graphical user interface to be a user two-dimensional or three-dimensional figure cursor.

The commodity database 104 stores a plurality of commodity icons. The commodity icons are provided by the designer, the manufacturer, the agent, and the seller of the popular commodity, such as clothes, ornaments, and decorations, etc. The commodity icons can be two-dimensional or three-dimensional static or dynamic icons. After the commodity database 104 receives the loaded user data from the remote computer 100 or the user database 102 via the network 101, a set of commodity icons that meets the characteristic of the loaded user data is selected according to the loaded user data, such as user's sex, hobby or the body outline, etc. Each commodity icon and a selection request are transmitted and displayed on the graphical user interface of the remote computer 100.

The remote computer 100 uses the input device to send the selection request displayed on the graphical user interface. The commodity database 104 receives the selection request sent by the remote computer 100 to accumulate the number of sent selection requests for each commodity icon. Therefore, according to the number of sent selection requests for each commodity icon, statistical data is outputted to the designer, the manufacturer, the agent, and the seller of a commodity so that the designer, the manufacturer, the agent, and the seller of the commodity can know how popular is their commodity.

The commodity icon corresponding to the sent selection request also is transmitted to the user database 102. According to the commodity icons, the user database 102 updates the loaded user data and transmits the user data to the remote computer 100. In this embodiment, the graphical user interface displays the two-dimensional or three-dimensional icon cursor with the commodity icon of the sent selection request that represents the user.

The remote computer 100 can uses the network 101 and the loaded user data to log in the network activity database 106. The network activity database 106 transmits a variety of operation requests to the remote computer 100 and displays on the graphical user interface. The remote computer 100 replies the variety of operation requests displayed on the graphical user interface by utilizing the user operates the input device. The network activity database 106 receives the sent operation request by the remote computer 100, and generates an evaluation result according to the sent operation request. The network activity database 106 also can be connected with a plurality of remote computers 100. The remote computers 100 respectively load user data from user database 102 to log in the network activity database 106, and respectively generate an evaluation result for each user data. In this embodiment, the network activity database 106 can be a network chat room, or an online game platform that can be developed and updated by a game developer. When the network activity database 106 is a network chat room, a virtual chat room with a three-dimensional dynamic icon is displayed on the graphical user interface, and a three-dimensional dynamic icon that represents the user and the other three-dimensional dynamic icons that represent the users log in from the other remote computers 100 are displayed on the graphical user interface. The user can give an evaluation result according to the icons displayed by the other users. The evaluation result is transmitted to the user database 102, and updates the loaded user data, such as the level, and experience of the user.

In this embodiment, the user database 102, the commodity database 104 and the network activity database 106 can be located in one server, or respectively located a plurality of servers. Each server includes a processing device, a storage device, an input device, and a wired or wireless communication device. The processing device includes a CPU, a DRAM, a RAM, a ROM, a graphic card, and an operation system. The user database 102, the commodity database 104 and the network activity database 106 are stored in the storage device of the server. The server is linked with the network 101 via the wires or wireless communication device. The storage device is a carry medium for recording the electronic data, such as hard disk, solid state disk, floppy disk, CD, DVD, Blue-ray disk, etc.

The collection, analysis and feedback system for consumption information of the present invention utilizes the sent selection request accumulated by the commodity database 104 to provide the designer, the manufacturer, the agent, and the seller of a commodity with information about how popular is the commodity. By providing the commodity icon to the commodity database 104, the hobby of the user is collected and analyzed to obtain the user group and the popular trend, and is then fed back to the designer, the manufacturer, the agent, and the seller of the commodity. Furthermore, the commodity icons stored in the commodity database 104 are updated, and the selection request of the updated commodity icons is transmitted to and displayed on the graphical user interface of the remote computer 100.

The evaluation result generated by the network activity database 106 also can be the reference evaluation of the selected commodity icons due to the user replies the selection request. Furthermore, by using the loaded user data to send the selection request of the commodity icons again to update the commodity matched with the two-dimensional or three-dimensional icon cursor that represents the user, the loaded user data in the network activity database 106 obtains a better evaluation result.

By using the collection, analysis and feedback system for consumption information of the present invention, the designer, the manufacturer, the agent and the seller can provide the commodity icons to obtain consumption information, such as the user's likes and the popular trends, and applies consumption information to their business activity, such as changing the design or the promotion strategy. Moreover, the user (the consumer) can obtain the reference evaluation represented by the evaluation result by selecting the commodity icon to know the popular consumption trend. Therefore, the trader and the consumer can interact with each other in the collection, analysis and feedback system for consumption information to obtain the required consumption information and prompt their commodity between different business activities.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A collection, analysis and feedback system for consumption information, including a remote computer, wherein the remote computer is connected with a network and displays a graphical user interface so that the user inputs or sets an option, comprising:
a user database storing a plurality of user data and connected with the remote computer via the network, wherein the user data respectively corresponds to a user code, and after the user database receives a user code from the remote computer, user data corresponding to the user code is loaded and is displayed on the graphical user interface of the remote computer;
a commodity database storing a plurality of commodity icons, wherein the commodity database receives a loaded user data from the remote computer or the user database via the network and selects a set of commodity icons according to the loaded user data, and each commodity icon and a selection request are transmitted to and displayed on the graphical user interface of the remote computer; and
a network activity database making the remote computer log in by using the loaded user data via the network, wherein the network activity database transmits a variety of operation requests to the remote computer, and displays the operation requests on the graphical user interface;
wherein by sending the selection requests to the commodity database and sending the operation requests to the network activity database using the remote computer, the commodity database accumulates the number of sent selection requests for the commodity icon and outputs statistical data and transmits the statistical data to the user database to update the loaded user data, and the network activity database generates an evaluation result according to the sent operation requests and transmits the evaluation result to the user database to update the loaded user data.

2. The collection, analysis and feedback system for consumption information as in claim 1, wherein the user data stored in the user database comprises sex, birthday, height, weight, hobby, resident area, education and body outline of the user.

3. The collection, analysis and feedback system for consumption information as in claim 1, wherein the network activity database provides a network chat room or an online game platform.

4. The collection, analysis and feedback system for consumption information as in claim 1, wherein the network activity database is connected with a plurality of remote computers, and the remote computers are respectively loading user data from the user database to log in the network activity database.
